(19) United States
(12) Patent Application Publication
(10) Pub. No.: US 2005/0086850 A1
(43) Pub. Date: Apr. 28, 2005

(54) Fishing line and methods for making the same

(76) Inventor: Norman Ernest Clough, Landenberg, PA (US)

Correspondence Address: GORE ENTERPRISE HOLDINGS, INC., 551 PAPER MILL ROAD, P. O. BOX 9206, NEWARK, DE, 19714-9206, US

(21) Appl. No.: 10/693,366

(22) Filed: Oct. 23, 2003

(51) Int. Cl. A01K 91/00

(52) U.S. Cl. 43/44.98

(57) ABSTRACT

High density polymeric fishing line having a density of at least about 1.9 g/cc. The polymeric fishing line preferably comprises fluoropolymer. Preferably the polymeric material has a modulus of at least about 200,000 psi and a tenacity of at least about 2.0 g/denier.

### BACKGROUND OF THE INVENTION

1. Field of the Invention

The present invention relates to improved fishing line and methods for making the same.

2. Description of Related Art

Many prior art materials have been used as fishing line material. For example it is known to manufacture fishing line from various polymer materials, such as nylon, aramid, polyethylene, polyvinylidene fluoride, etc. Such fishing line generally is provided as a core material, which can be monofilament, a plurality of monofilaments twisted together, or braided filaments. Such filament constructions are referred to as the core. Prior art fishing lines provide the core with an outer surface treatment, coating or sheath material, wherein the core provides certain desired properties and the outer surface treatment, coating or sheath material provides certain desired properties. Important properties of fishing line depend on the actual application (e.g., fly fishing, etc.) and include, for example, line sensitivity (as felt by the angler), coefficient of friction, density, stiffness, optical quality, abrasion resistance, high knot strength, hydrophobicity, low visibility, and tenacity.

Known in the art are fibers having a wide range of densities. However, the prior art does not disclose fishing line having a density substantially higher than that of water.

Also known are fibers comprising polytetrafluoroethylene (PTFE). Such fibers can be produced by methods known in the art. For example, it is known to form PTFE fibers by wet spinning a dispersion of PTFE, and heating to a temperature of from about 340° C. to about 400° C. Other techniques are known, such as spinning an emulsion of PTFE or extruding a paste of PTFE, and sintering the resultant fibrous PTFE at a temperature not lower than the crystalline melting point of the PTFE, followed by drawing at a temperature of about 340° C. to about 400° C. at a draw ratio of 2 to 30 times.

Also known are fibers comprising expanded PTFE. Such fibers can be obtained from films of expanded PTFE, which can be fabricated as taught by U.S. Pat. Nos. 3,953,566; 3,962,153; and 4,187,390. In the process taught by these patents a paste obtained by mixing a lubricant, such as mineral spirits, with polytetrafluoroethylene is paste extruded, the resultant molded product is drawn at a temperature lower than the crystalline melting point of polytetrafluoroethylene and at a high drawing rate, followed by sintering under restraint from shrinkage, at a temperature higher than the crystalline melting point to obtain a porous article. The porous article has high mechanical strength, even if the porous article is in the form of a yarn. Such fibers are commercially available from W. L. Gore and Associates, Inc., of Newark, Del.

The present inventor has discovered that certain fishing line applications could benefit from the use of fishing line having a density higher than that known heretofore. Higher density fishing line will result in, among other things, improved sinkability of the line along with an increase in “sensitivity,” both desirable properties to the angler.

Accordingly, it is a primary purpose of the present invention to provide such a fishing line material, as well as methods for making the same.

These and other purposes of the present invention will become evident from review of the following specification.

### SUMMARY OF THE INVENTION

The present invention provides high density, polymeric fishing line and methods for making the same. The polymeric fishing line comprises at least one fiber and has a density of at least about 1.9 g/cc. In an aspect of the invention, the polymeric fishing line has a tenacity of at least about 2.0 g/denier.

In an aspect of the invention the polymeric fishing line has a diameter of at least about 0.004 inch (0.01 cm). In a further aspect of the invention the polymeric fishing line has a diameter of at least about 0.006 inch (0.015 cm).

In an aspect of the invention, the polymeric fishing line has a tensile modulus of at least about 200,000 psi. In a further aspect of the invention the polymeric fishing line has a tensile modulus of at least about 1×10⁶ psi. In still a further aspect of the invention the polymeric fishing line has a tensile modulus of at least about 6×10⁶ psi. Preferred polymeric fishing lines have a tensile modulus of from about 200,000 psi to about 10×10⁶ psi. In an aspect of the invention the polymeric fishing line comprises at least one fiber having a mass per unit length of at least about 150 denier. In a further aspect of the invention the polymeric fishing line comprises at least one fiber having a mass per unit length of at least about 400 denier.

### BRIEF DESCRIPTION OF THE FIGURES

FIG. 1 is a perspective view of a fishing rod assembly according to the present invention;

FIG. 2 is a perspective view of a polymeric fishing line of the twisted fiber construction according to the present invention;

FIG. 3 is a cross-section view of a polymeric fishing line of the invention;

FIG. 4 is a cross-section view of a polymeric fishing line of the invention;

FIG. 5 is a cross-section view of a polymeric fishing line of the invention; and

FIG. 6 is a cross-section view of a polymeric fishing line of the invention.

### DETAILED DESCRIPTION OF THE INVENTION

The invention provides high density, polymeric fishing line and methods for making the same. The polymeric fishing line has a density of at least about 1.9 g/cc. In an aspect of the invention the polymeric fishing line has a density of at least about 2.0 g/cc. In a further aspect of the invention the polymeric fishing line has a density of at least about 2.1 g/cc. In a still further aspect of the invention, the polymeric fishing line has a density of at least about 2.2 g/cc.

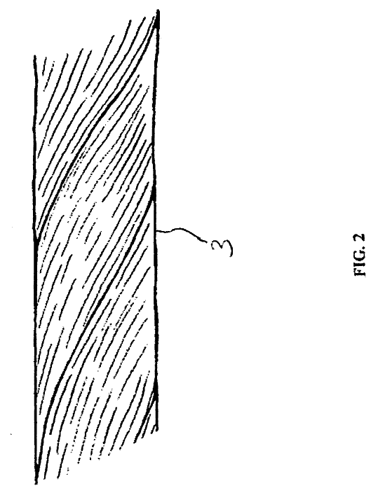

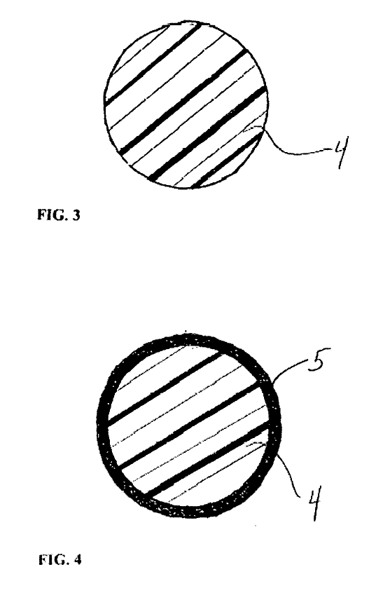

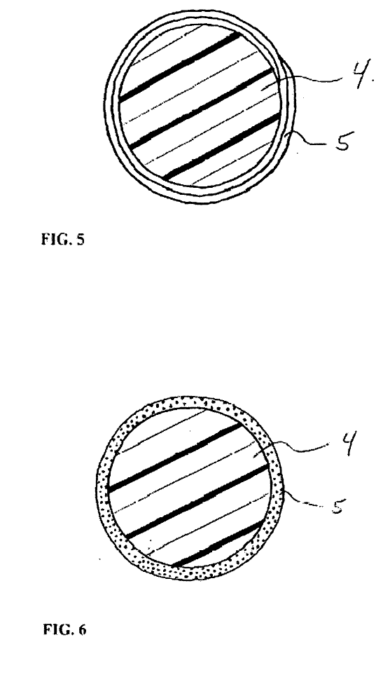

As used herein the term “polymeric fishing line” can be the “core” of the fishing line which includes a monofilament, a plurality of monofilaments twisted together (as demonstrated in FIG. 2 which shows fishing line 3 in a twisted construction), a plurality of monofilaments in a braided construction, or any other suitable fiber configuration which would result in a suitable fishing line. Such a fishing line core material is shown in cross-section in FIG. 3, wherein core material is indicated by the numeral 4. “Polymeric fishing line” also can be a construction which includes a core material as discussed above which has been modified to include outer surface treatment(s), outer coating(s), or sheath material(s), etc., located on at least a portion of the core material. Preferably, such surface modification(s) covers substantially the entire outer surface of the core material. FIG. 4 is representative of such a polymeric fishing line construction wherein the core material is indicated by the numeral 4 and a suitable coating or sheath material is indicated by numeral 5. FIG. 5 shows a further representative construction wherein core material is indicated by numeral 4 and coating 5 is in the form of a multiple wrap construction. Finally, FIG. 6 further demonstrates yet another embodiment of such a construction wherein core material is indicated by numeral 4 and coating 5 further includes a filler material.

Any polymeric material, or combinations of polymeric materials, that can be manufactured to have a density of at least about 1.9 g/cc may be suitable. Preferred polymeric materials are fluoropolymers. For example, suitable fluoropolymers include polytetrafluoroethylene, perfluoroalkoxy, fluorinated ethylene propylene, and fluorinated terpolymer of tetrafluoroethylene, hexafluoropropylene, and vinylidene fluoride. Preferred fluoropolymer is polytetrafluoroethylene and even more preferred is a unique form of polytetrafluorethylene known as expanded polytetrafluoroethylene. Polytetrafluoroethylene is particularly advantageous when the fishing line is not provided with an outer coating or sheath material.

It has also been discovered that in addition to the above-discussed density, particularly attractive polymeric fishing lines have a tensile modulus of at least about 200,000 psi. In a further aspect of the invention the polymeric fishing line has a tensile modulus of at least about 1×10⁶ psi. In still a further aspect of the invention the polymeric fishing line has a tensile modulus of at least about 6×10⁶ psi. Preferred polymeric fishing lines have a tensile modulus of from about 200,000 psi to about 10×10⁶ psi.

The fishing line of the invention also may have a tenacity of at least about 2.0 g/denier. In an aspect of the invention the fishing line has a tenacity of at least about 3.0 g/denier. In a further aspect of the invention the fishing line has a tenacity of at least about 4.0 g/denier. In a still further aspect of the invention the fishing line has a tenacity of at least about 5.0 g/denier. In yet a further aspect of the invention the fishing line has a tenacity of at least about 6.0 g/denier.

Moreover, preferred polymeric fishing lines comprise at least one fiber having a mass per unit length of at least about 150 denier. More preferred polymeric fishing lines comprise at least one fiber having a mass per unit length of at least about 400 denier.

Preferred polymeric fishing lines have a diameter of at least about 0.004 inch (0.01 cm). Even more preferred are polymeric fishing lines having a diameter of at least about 0.006 inch (0.015 cm).

Moreover, it is also possible to include desired pigments to produce a fishing line of desired color. For example it may be desirable to produce substantially translucent fishing line (in which case no pigments need be added to certain fiber materials, e.g., polytetrafluoroethylene), green fishing line, blue fishing line, etc.

Furthermore, suitable filler materials can be added to, or combined with, the polymeric material to form a polymeric core material comprising polymer and at least one filler. Suitable filler material can be, for example, other polymeric materials, metals, ceramics, etc.

As stated above, a particularly preferred polymeric material for use in the invention is polytetrafluoroethylene and even more preferred is expanded polytetrafluoroethylene. Such expanded polytetrafluoroethylene fibers are commercially available from W.L. Gore and Associates, Inc., of Newark, Del. High denier materials are preferred.

It has been found particularly attractive to subject expanded polytetrafluoroethylene fibers to further processing to result in fibers having improved properties, such as increased tenacity. The process includes subjecting the fiber to at least one additional heating and stretching step. Preferably the fiber is drawn over a heating means, such as a heating plate, heated from about 350° C. to about 440° C. The stretching rates can vary, as well as the number of heating/stretching steps carried out. Furthermore, particularly preferred polytetrafluoroethylene fishing lines comprise at least two fibers in a twisted construction to form a core material (as demonstrated with particularity in Examples 2A-2E, below). After twisting, additional heating, stretching and/or shrinking steps may be carried out to alter the modulus of the fishing line.

It should be understood that the polymeric fishing line may include at least one material in addition to the polymer material. In this regard suitable additional materials include, for example, other polymer materials, metallic fillers, ceramic fillers, etc. Such other materials may be added to improve one or more properties of the fishing line, while still maintaining a fishing line density of at least about 1.9 g/cc. One skilled in the art will understand how such materials may be included with the polymer material.

Moreover, the polymeric fishing line of the invention may also comprise a polymeric core material which has been surface modified in some way. For example, polymeric fishing line may include a core material which has been etched, or plasma treated to alter the surface thereof. Furthermore, the core may be provided with a coating material which may be adhered to or wrapped about the core. Moreover, a coating material may be laminated to the surface of the core material. In an aspect of the invention a film or membrane of expanded polytetrafluoroethylene may be adhered to, wrapped about, or laminated to the core material. Furthermore, the coating material may include one or more suitable filler materials to further effect the properties of the coating. This embodiment is shown in cross-section in FIG. 6. For example, polymeric, metallic or ceramic filler materials could be provided to the expanded polytetrafluoroethylene which is adhered to, wrapped about, or laminated to the core material.

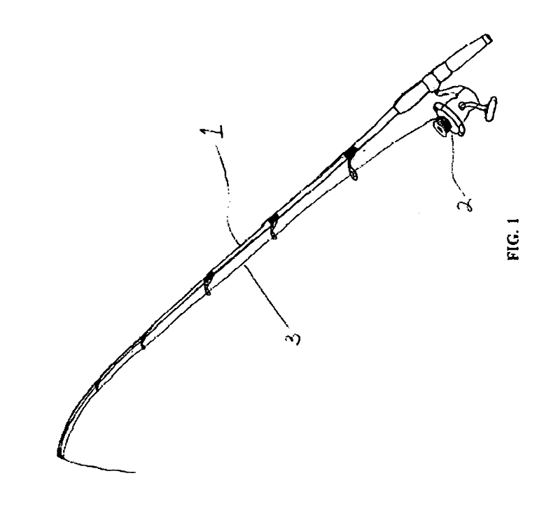

The invention also relates to a fishing rod, reel, and fishing line assembly, which includes an elongated rod portion, a reel for holding/dispensing/taking-up line, and polymeric fishing line having a density of at least about 1.9 g/cc. FIG. 1 shows such a fishing rod assembly wherein the rod is indicated by 1, the reel by 2, and the polymeric fishing line by 3.

Without intending to limit the scope of the present invention, the following examples illustrate how the present invention may be made and used:

Tensile Test and Tenacity Calculation:

Prior to tensile testing, the fiber denier was determined by weighing a 9 meter length sample of the fiber on a Denver Instruments. Inc. Model M160 analytical balance and multiplying the mass which was expressed in grams, by 1000. Tensile testing was conducted at ambient temperature on a tensile test machine (Zellweger USTER®TENSORAPID 4) equipped with pneumatic fiber grips, set to a sample length of 269 mm. The sample is automatically loaded into the grips and clamped. The peak force is recorded as the grips move apart at a speed of 254 mm/min. Five samples were tested within an approximate 2.9 meter length of the fiber. The tenacity of each fiber sample expressed in grams/denier was calculated by dividing the peak force expressed in grams by the denier value of the fiber. The tenacity value for each of the five samples is calculated and the maximum and minimum values reported as the tenacity range.

Density Measurement:

Fiber and/or fishing line density is determined using the “principle of buoyancy” or simply, Archimedes principle which states that a body immersed in a fluid will be subjected to a buoyancy force equal to the weight of the displaced fluid. Buoyancy force or the weight of the displaced fluid, is calculated from the initial fiber mass and the fiber mass during full immersion in the fluid. From the mass of the displaced fluid and the fluid density, the fluid volume displaced can be calculated and represents the total volume of the fiber. Using the initial “dry” mass of the fiber and the fiber volume, the fiber and/or fishing line density can be calculated.

Determination of Water Density

A Duran glass volume standard was used to determine water density. This glass standard was certified to have a volume of 10+/−0.001 cubic centimeters (cc). During the experiment, the room temperature was recorded at 70° F. (21° C.). The glass standard was placed on a Mettler-Toledo AG204 series balance equipped with an integral immersion densitometer, previously tared to zero and the mass was noted at 30.0400 g. A support was then placed over the balance base to allow a deionized water container to be placed over but not in contact with the balance. A support crucible was then suspended from the center of the balance into the water container and not allowed to contact the sides of the container. Any air bubbles attached to the crucible were removed by gentle agitation. The balance was then tared to zero. The glass standard was then carefully placed on the crucible and fully immersed in the water container, avoiding contact with the sides of the container. Any air bubbles attached to the glass standard after immersion in the water container were removed by gentle agitation of the glass standard on the crucible. The mass of the fully immersed glass standard was noted at 20.0683 g. The density of water was calculated as follows:
Buoyancy Mass for the 10cc glass standard=30.0400g−20.0683g=9.9717g
Water Density=9.9717/10cc=0.9972g/cc.
Determination of Fiber Density

All fibers and/or fishing lines (or twisted fiber constructions of Examples 2A-2E) are tested using the following procedure. A fiber sample was placed on a Mettler-Toledo AG204 series balance equipped with an integral immersion densitometer and the mass noted in grams (A).

As described above in the density determination of water, a support was placed over the balance base to allow a water container to be placed over but not in contact with the balance. A support crucible was then suspended from the center of the balance into the water container and not allowed to contact the sides of the container. Any air bubbles attached to the crucible after immersion in the water container were removed by gentle agitation. The balance was then tared to zero. The fiber sample was then carefully placed on the crucible and fully immersed in the water container avoiding contact with the sides of the container. Any air bubbles attached to the fiber after immersion in the water container were removed by gentle agitation of the fiber on the crucible. The mass of the fully immersed fiber was noted in grams (B). The density of the fiber sample was calculated as follows:
Fiber sample Density(g/cc)=A/((A−B)/0.9972)
Tensile Modulus Calculation:

For Examples 2A-2E, fiber modulus was calculated using the following procedure. Tensile testing was conducted at ambient temperature using a tensile test machine (INSTRON Tensile Tester) equipped with pneumatic fiber grips, set for a sample gauge length of 269 mm. The sample was manually loaded into the grips and clamped. The force-elongation data were recorded as the grips moved apart at a speed of 254 mm/min. The elongation at break was recorded and the percent elongation at break was calculated. Elongation at break was defined as the elongation corresponding to the peak force. In keeping with standard procedures for determining modulus, the slope of the stress-strain curve was calculated for the essentially linear portion of the curve. This generally extended from the origin through to strains corresponding to elongations of approximately 1% to 13%, depending on the ultimate % elongation of the example. From the mean density values and the fiber denier, the mean fiber cross-sectional area was determined and used to calculate fiber tensile modulus in the essentially linear range of the stress-strain profile.

### EXAMPLE 1

Samples of commercial 1156 denier and 1136 denier PTFE fiber were obtained from W.L. Gore & Associates. Inc., Newark Del. Five samples from each fiber sample were tested according to the above tensile test procedure. The tenacity range for the 1156 and 1136 denier fibers was 5.3-5.5 g/d and 5.2-5.6 g/d, respectively. A 1156 denier fiber and a 1136 denier fiber were twisted together at 7 twists per inch in the Z direction to form a twisted fiber construction. The twisted fiber was stretched over a hot plate at a temperature of 350° C. and a stretch ratio of 1.04:1, a second hot plate at a temperature of 355° C. and a stretch ratio of 1.04:1, a third hot plate at a temperature of 365° C. and a stretch ratio of 1.04:1, a fourth hot plate at a temperature of 365° C. and a stretch ratio of 1.04:1 and finally over a hot plate heated at 410° C. at a stretch ratio of 1.45:1. The final overall stretch ratio was 1.696:1. The output speed was 60 feet of fiber per minute. The denier of this fiber was measured to be 1467. Five samples from this fiber were tested according to the above tensile test procedure. The tenacity range for these samples was 6.3-6.7 g/d. From three separate measurements, the density range for these samples was 2.106-2.270, with a mean density of 2.201.

Details for Example 1 are summarized in Table 1 below:

TABLE 1

Example 1

| | | |
|---|---|---|
| Initial Denier (d) | 1156 | 1136 |
| Initial Tenacity | 5.3-5.5 | 5.2-5.6 |
| Range (g/d) | | |

| | |
|---|---|
| Total Stretch Ratio | 1.696:1 |
| Output Speed (fpm) | 60 |
| Final Denier (d) | 1467 |
| Final Tenacity | 6.3-6.7 |
| Range (g/d) | |

### EXAMPLE 2

Five samples of the final PTFE fiber of Example 1 were subjected to further thermal processing. These process details are outlined in Examples 2A-2E. The density of the final fiber from Examples 2A-2E was determined at ambient using the Archimedes buoyancy method. The measurement for each fiber was carried out on 3 separate samples and the mean density calculated.

### EXAMPLE 2A

The final fiber of Example 1 was passed over a hot plate at a temperature of 335° C. and a ratio of 1:1, a second hot plate at a temperature of 355° C. and a ratio of 1:1, a third hot plate at a temperature of 430° C. and a ratio of 0.85:1, a fourth hot plate at a temperature of 410° C. and a ratio of 1:1 and finally over a hot plate heated at 410° C. at a ratio of 1:1. The final overall ratio was 0.85:1. The output speed was 50 feet of fiber per minute. After treatment, the denier of this fiber was measured to be 1747. Five samples from this fiber were tested according to the above tensile test procedure. The tenacity range for these samples was 3.6-4.1 g/d. From 3 separate measurements, the density range for these samples was 2.196-2.208 with a mean density of 2.203.

### EXAMPLE 2B

The final fiber of Example 1 was passed over a hot plate at a temperature of 335° C. and a ratio of 1:1, a second hot plate at a temperature of 355° C. and a ratio of 1:1, a third hot plate at a temperature of 430° C. and a ratio of 0.95:1, a fourth hot plate at a temperature of 410° C. and a ratio of 1:1 and finally over a hot plate heated at 410° C. at a ratio of 1:1. The final overall ratio was 0.95:1. The output speed was 50 feet of fiber per minute. After treatment, the denier of this fiber was measured to be 1540. Five samples from this fiber were tested according to the above tensile test procedure. The tenacity range for these samples was 4.2-4.9 g/d. From 3 separate measurements, the density range for these samples was 2.192-2.222 with a mean density of 2.207.

### EXAMPLE 2C

The final fiber of Example 1 was passed over a hot plate at a temperature of 335° C. and a ratio of 1:1, a second hot plate at a temperature of 355° C. and a ratio of 1:1, a third hot plate at a temperature of 440° C. and a ratio of 0.85:1, a fourth hot plate at a temperature of 410° C. and a ratio of 1:1 and finally over a hot plate heated at 410° C. at a ratio of 1:1. The final overall ratio was 0.85:1. The output speed was 100 feet of fiber per minute. After treatment, the denier of this fiber was measured to be 1728. Five samples from this fiber were tested according to the above tensile test procedure. The tenacity range for these samples was 4.0-4.6 g/d. From 3 separate measurements, the density range for these samples was 2.194-2.205 with a mean density of 2.199.

### EXAMPLE 2D

The final fiber of Example 1 was passed over a hot plate at a temperature of 335° C. and a ratio of 1:1, a second hot plate at a temperature of 355° C. and a ratio of 1:1, a third hot plate at a temperature of 440° C. and a ratio of 0.7:1, a fourth hot plate at a temperature of 410° C. and a ratio of 1:1 and finally over a hot plate heated at 410° C. at a ratio of 1:1. The final overall ratio was 0.7:1. The output speed was 100 feet of fiber per minute. After treatment, the denier of this fiber was measured to be 2076. Five samples from this fiber were tested according to the above tensile test procedure. The tenacity range for these samples was 2.8-3.3 g/d. From 3 separate measurements, the density range for these samples was 2.158-2.171 with a mean density of 2.166.

### EXAMPLE 2E

The final fiber of Example 1 was passed over a hot plate at a temperature of 335° C. and a ratio of 1:1, a second hot plate at a temperature of 355° C. and a ratio of 1:1, a third hot plate at a temperature of 365° C. and a ratio of 1:1, a fourth hot plate at a temperature of 365° C. and a ratio of 1:1 and finally over a hot plate heated at 410° C. at a ratio of 1.4:1. The final overall ratio was 1.4:1. The output speed was 50 feet of fiber per minute. After treatment, the denier of this fiber was measured to be 1035. Five samples from this fiber were tested according to the above tensile test procedure. The tenacity range for these samples was 5.5-6.4 g/d. From 3 separate measurements, the density range for these samples was 2.210-2.226 with a mean density of 2.219.

Details for Examples 2A-2E are summarized in Table 2 below:

TABLE 2

| | Ex. 2A | Ex. 2B | Ex. 2C | Ex. 2D | Ex. 2E |
|---|---|---|---|---|---|
| Total Stretch | 0.85:1 | 0.95:1 | 0.85:1 | 0.7:1 | 1.4:1 |
| or Shrinkage | | | | | |
| Ratio | | | | | |
| Output | 50 | 50 | 100 | 100 | 50 |
| Speed (fpm) | | | | | |
| Denier (d) | 1747 | 1540 | 1728 | 2076 | 1035 |
| Tenacity | 3.6-4.1 | 4.2-4.9 | 4.0-4.6 | 2.8-3.3 | 5.5-6.4 |
| Range (g/d) | | | | | |
| Density | 2.203 | 2.207 | 2.199 | 2.166 | 2.219 |
| (g/cc) | | | | | |
| Modulus | 1171 | 2314 | 629 | 240 | 9216 |
| (Kpsi) | | | | | |
| % Elonga- | 16.84 | 9.69 | 20.31 | 33.39 | 5.52 |
| tion at Break | | | | | |

While particular embodiments of the present invention have been illustrated and described herein, the present invention should not be limited to such illustrations and descriptions. It should be apparent that changes and modifications may be incorporated and embodied as part of the present invention within the scope of the following claims.

1. Polymeric fishing line having a density of at least about 1.9 g/cc.

2. The fishing line of claim 1, wherein the density of the fishing line is at least about 2.0 g/cc.

3. The fishing line of claim 2, wherein the density of the fishing line is at least about 2.1 g/cc.

4. The fishing line of claim 3, wherein the density of the fishing line is at least about 2.2 g/cc.

5. The fishing line of claim 1, wherein the polymer comprises a fluoropolymer.

6. The fishing line of claim 5, wherein the fluoropolymer is selected from the group consisting of polytetrafluoroethylene, perfluoroalkoxy, fluorinated ethylene propylene, and fluorinated terpolymer of tetrafluoroethylene, hexafluoropropylene, and vinylide fluoride.

7. The fishing line of claim 6, wherein the fluoropolymer is polytetrafluoroethylene.

8. The fishing line of claim 7, wherein the polytetrafluoroethylene is expanded polytetrafluoroethylene.

9. The fishing line of claim 8, wherein the expanded polytetrafluoroethylene further includes at least one filler material.

10. The fishing line of claim 1, wherein the fishing line comprises a polymeric core including at least one filler material.

11. The fishing line of claim 1, wherein the fishing line comprises at least one fiber having a mass to unit length of at least about 150 denier.

12. The fishing line of claim 11, wherein the at least one fiber has a mass to unit length of at least about 400 denier.

13. The fishing line of claim 1, wherein the fishing line has a tensile modulus of at least about 200,000 psi.

14. The fishing line of claim 13, wherein the fishing line has a tensile modulus of from about 200,000 psi to about 10×10⁶ psi.

15. The fishing line of claim 13, wherein the fishing line has a tensile modulus of at least about 1×10⁶ psi.

16. The fishing line of claim 15, wherein the fishing line has a tensile modulus of at least about 6×10⁶ psi.

17. The fishing line of claim 11, wherein the fishing line has a tensile modulus of at least about 200,00 psi.

18. The fishing line of claim 1, wherein the fishing line has a tenacity of at least about 2.0 g/denier.

19. The fishing line of claim 1, wherein the fishing line further comprises at least some pigment.

20. The fishing line of claim 1, wherein the fishing line is a monofilament.

21. The fishing line of claim 1, wherein the fishing line comprises a plurality of fibers in a braided construction.

22. The fishing line of claim 1, wherein the fishing line comprises a plurality of fibers in a twisted construction.

23. The fishing line of claim 1, wherein the fishing line comprises a core material which has been surface modified.

24. The fishing line of claim 23, wherein the surface has been modified by at least one of etching and plasma treatment.

25. The fishing line of claim 1, wherein the fishing line comprises a core material which is provided with at least one coating material.

26. The fishing line of claim 25, wherein the at least one coating comprises expanded polytetrafluoroethylene.

27. The fishing line of claim 25, wherein the at least one coating further includes at least some filler material.

28. The fishing line of claim 23, wherein the core material is a monofilament.

29. The fishing line of claim 23, wherein the core material comprises a plurality of fibers.

30. The fishing line of claim 25, wherein the core material is a monofilament.

31. The fishing line of claim 25, wherein the core material comprises a plurality of fibers.

32. Polymeric fishing line comprising polytetrafluoroethylene fiber having a density of at least about 1.9 g/cc.

33. The fishing line of claim 32, wherein the fiber has a density of at least about 2.0 g/cc.

34. The fishing line of claim 33, wherein the fiber has a density of at least about 2.1 g/cc.

35. The fishing line of claim 34, wherein the fiber has a density of at least about 2.2 g/cc.

36. The fishing line of claim 32, wherein the polytetrafluoroethylene is expanded polytetrafluoroethylene.

37. The fishing line of claim 32, wherein the fishing line further comprises at least one filler material.

38. The fishing line of claim 32, wherein the fishing line comprises a monofilament core material.

39. The fishing line of claim 32, wherein the fishing line comprises a core material of a plurality of fibers in a braided construction.

40. The fishing line of claim 32, wherein the fishing line comprises a core material of a plurality of fibers in a twisted construction.

41. The fishing line of claim 32, comprising at least one fiber having a mass to unit length of at least about 150 denier.

42. The fishing line of claim 41, wherein the at least one fiber has a mass to unit length of at least about 400 denier.

43. The fishing line of claim 32, wherein the fishing line has a tensile modulus of at least about 200,000 psi.

44. The fishing line of claim 43, wherein the fishing line has a tensile modulus of from about 200,000 psi to about 10×10⁶ psi.

45. The fishing line of claim 43, wherein the fishing line has a tensile modulus of at least about 1×10⁶ psi.

46. The fishing line of claim 45, wherein the fishing line has a tensile modulus of at least about 6×10⁶ psi.

47. The fishing line of claim 41, wherein the fiber has a tensile modulus of about at least about 200,000 psi.

48. The fishing line of claim 32, wherein the fishing line further comprises at least some pigment.

49. The fishing line of claim 32, wherein the fishing line consists essentially of polytetrafluoroethylene.

50. The fishing line of claim 32, wherein the fishing line has a tenacity of at least about 2.0 g/denier.

51. The fishing line of claim 32, wherein the fishing line comprises a core material which has been surface modified.

52. The fishing line of claim 51, wherein the surface has been modified by at least one of etching and plasma treatment.

53. The fishing line of claim 32, wherein the fishing line comprises a core material which is provided with at least one coating material.

54. The fishing line of claim 53, wherein the at least one coating material comprises expanded polytetrafluoroethylene.

55. The fishing line of claim 53, wherein the at least one coating material further includes at least one filler material.

56. The fishing line of claim 51, wherein the core material is a monofilament.

57. The fishing line of claim 51, wherein the core material comprises a plurality of fibers.

58. The fishing line of claim 53, wherein the core material is a monofilament.

59. The fishing line of claim 53, wherein the core material comprises a plurality of fibers.

60. A fishing rod comprising:
an elongated rod portion;
a reel; and
polymeric fishing line having a density of at least about 1.9 g/cc.
